(19) United States
(12) Patent Application Publication
(10) Pub. No.: US 2025/0227579 A1
(43) Pub. Date: Jul. 10, 2025

(54) HANDOVER FOR SIDELINK RELAY USER EQUIPMENT

(71) Applicant: Telefonaktiebolaget LM Ericsson (PUBL), Stockholm (SE)

(72) Inventors: Antonino Orsino, KIRKKONUMMI (FI); Liwei Qiu, TÄBY (SE)

(21) Appl. No.: 18/853,944

(22) PCT Filed: Apr. 4, 2023
(86) PCT No.: PCT/IB2023/053420

§ 371 Date: Oct. 3, 2024

Related U.S. Application Data
(60) Provisional application No. 63/362,409, filed on Apr. 4, 2022.

(51) Int. Cl. H04W 36/08; H04W 76/10; H04W 76/20; H04W 92/18

(52) U.S. Cl. CPC H04W 36/08; H04W 76/10; H04W 76/20; H04W 92/18

(57) ABSTRACT

According to some embodiments, a method is performed by a source network node for performing a sidelink path switch. The method comprises determining to switch a remote wireless device to sidelink communication with a target relay wireless device. The target relay wireless device is in an idle or inactive state and the target relay wireless device is served by a target network node different from the source network node. The method further comprises transmitting an indication to the target network node of the path switch involving the target relay wireless device.

### TECHNICAL FIELD

Particular embodiments relate to wireless communication, and more specifically to handover for sidelink relay user equipment.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) new radio (NR) networks include sidelink communications. Sidelink transmissions over NR are specified for Release 16. These are enhancements of the ProSe (PROximity-based SErvices) specified for long term evolution (LTE). Four new enhancements are introduced to NR sidelink (SL) transmissions.

One enhancement is support for unicast and groupcast transmissions. For unicast and groupcast, the physical sidelink feedback channel (PSFCH) is introduced for a receiver user equipment (UE) to send a decoding status to a transmitter UE. Another enhancement is grant-free transmissions, which are adopted in NR uplink transmissions, and are also provided in NR sidelink transmissions, to improve the latency performance. To alleviate resource collisions among different sidelink transmissions launched by different UEs, enhanced channel sensing and resource selection procedures are included, which also lead to a new design for physical sidelink control channel (PSCCH). To achieve a high connection density, congestion control and thus the QoS management is supported in NR sidelink transmissions.

To enable the above enhancements, new physical channels and reference signals are introduced in NR (available in LTE before.).
PSSCH (Physical Sidelink Shared Channel, SL version of physical downlink shared channel (PDSCH)): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink, SL version of physical uplink control channel (PUCCH)): The PSFCH is transmitted by a sidelink receiver UE for unicast and groupcast, which conveys 1 bit information over 1 resource block (RB) for the hybrid automatic repeat request (HARQ) acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of physical downlink control channel (PDCCH)): When the traffic to be sent to a receiver UE arrives at a transmitter UE, a transmitter UE firsts send the PSCCH, which conveys a part of SCI (Sidelink Control information, SL version of downlink control information (DCI)) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (referred to as S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is referred to as initial cell search. The UE sending the S-PSS/S-SSS may not be necessarily involved in sidelink transmissions, and a node (UE/eNB/gNB) sending the S-PSS/S-SSS is referred to as a synchronization source. There are two S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. The SSB is transmitted periodically every 160 ms.
DMRS, phase tracking reference signal (PT-RS), channel state information reference signal (CSI-RS): These physical reference signals supported by NR downlink/uplink transmissions are also adopted by sidelink transmissions. Similarly, the PT-RS is only applicable for frequency range two (FR2) transmission.

Another new feature is the two-stage sidelink control information (SCI). This is a version of the DCI for SL. Unlike the DCI, only part (first stage) of the SCI is sent on the PSCCH. This part is used for channel sensing (including the reserved time-frequency resources for transmissions, DMRS pattern and antenna port, etc.) and can be read by all UEs while the remaining (second stage) scheduling and control information, such as an 8-bits source identity (ID) and a 16-bits destination ID, new data indication (NDI), redundancy version (RV) and HARQ process ID is sent on the PSSCH to be decoded by the receiver UE.

Similar as for PROSE in LTE, NR sidelink transmissions include the following two modes of resource allocations: Mode 1, sidelink resources are scheduled by a gNB; and Mode 2, the UE autonomously selects sidelink resources from a (pre-) configured sidelink resource pool(s) based on the channel sensing mechanism.

For an in-coverage UE, a gNB may be configured to use Mode 1 or Mode 2. For an out-of-coverage UE, only Mode 2 may be used.

As in LTE, scheduling over the sidelink in NR is done in different ways for Mode 1 and Mode 2. Mode 1 supports dynamic grant and configured grant.

For dynamic grant, when the traffic to be sent over sidelink arrives at a transmitter UE, the transmitter UE launches the four-message exchange procedure to request sidelink resources from a gNB (scheduling request (SR) on uplink (UL), grant, buffer status report (BSR) on UL, grant for data on SL sent to UE). During the resource request procedure, a gNB may allocate a sidelink radio network temporary identifier (SL-RNTI) to the transmitter UE. If the sidelink resource request is granted by a gNB, then the gNB indicates the resource allocation for the PSCCH and the PSSCH in the DCI conveyed by PDCCH with cyclic redundancy check (CRC) scrambled with the SL-RNTI.

When a transmitter UE receives such a DCI, the transmitter UE may obtain the grant only if the scrambled CRC of DCI can be successfully solved by the assigned SL-RNTI. A transmitter UE then indicates the time-frequency resources and the transmission scheme of the allocated PSSCH in the PSCCH and launches the PSCCH and the PSSCH on the allocated resources for sidelink transmissions. When a grant is obtained from a gNB, a transmitter UE can only transmit a single transport block (TB). As a result, this kind of grant is suitable for traffic with a loose latency requirement.

With configured grant, for traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, the UE can launch the PSCCH and the PSSCH on the upcoming resource occasion. This kind of grant is also referred to as grant-free transmission.

In both dynamic grant and configured grant, a sidelink receiver UE cannot receive the DCI (because it is addressed to the transmitter UE). Therefore, a receiver UE performs blind decoding to identify the presence of PSCCH and find the resources for the PSSCH through the SCI.

When a transmitter UE launches the PSCCH, cyclic redundancy check (CRC) is also inserted in the SCI without scrambling.

In Mode 2 resource allocation, when traffic arrives at a transmitter UE, the transmitter UE autonomously selects resources for the PSCCH and the PSSCH. To further minimize the latency of the feedback HARQ ACK/NACK transmissions and subsequent retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also referred to as blind retransmission. As a result, when traffic arrives at a transmitter UE, the transmitter UE selects resources for the following transmissions: (a) the PSSCH associated with the PSCCH for initial transmission and blind retransmissions, and (b) the PSSCH associated with the PSCCH for retransmissions.

Because each transmitter UE in sidelink transmissions autonomously selects resources for the above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring reference signal received power (RSRP) on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

There are device to device (D2D) discovery procedures for detection of services and applications offered by other UEs in close proximity. This is part of LTE Rel 12 and Rel 13. The discovery procedure has two modes, mode A based on open announcements (broadcasts) and mode B, which is request/response. The discovery mechanism is controlled by the application layer (e.g., the ProSe layer). In NR the discovery message is sent on the PSSCH. The discovery procedure may be used to detect UEs supporting certain services or applications before initiating the communication. Both dedicated discovery resource pool (i.e., only discovery message can be transmitted in the pool) and shared resource pool configuration (i.e., both discovery message and other data and control messages can be transmitted in the pool) are supported in NR. Whether a dedicated discovery resource pool is configured is based on network implementation.

TR 23.752 clause 6.7 describes the layer-2 based UE-to-Network relay. This clause provides the protocol architecture supporting a L2 UE-to-Network Relay UE. The L2 UE-to-Network Relay UE provides forwarding functionality that can relay any type of traffic over the PC5 link.

The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

FIG. 1 illustrates the protocol stack for the user plane transport, related to a protocol data unit (PDU) session, including a layer 2 UE-to-network relay UE. FIG. 1 is reproduced from Figure A.2.1-1 in TR 23.752.

The PDU layer corresponds to the PDU carried between the remote UE and the data network (DN) over the PDU session. The two endpoints of the Packet Data Conversion Protocol (PDCP) link are the remote UE and the gNB. The relay function is performed below PDCP. This means that data security is ensured between the remote UE and the gNB without exposing raw data at the UE-to-network relay UE.

The adaptation relay layer within the UE-to-network relay UE can differentiate between signaling radio bearers (SRBs) and data radio bearers (DRBs) for a particular remote UE. The adaptation relay layer is also responsible for mapping PC5 traffic to one or more DRBs of the Uu.

FIG. 2 illustrates the protocol stack of the non-access stratum (NAS) connection for the remote UE to the NAS-MM and NAS-SM components. FIG. 2 is reproduced from Figure A.2.2-1 in TR 23.752.

The NAS messages are transparently transferred between the remote UE and 5G-AN over the layer 2 UE-to-network relay UE using: (a) PDCP end-to-end connection where the role of the UE-to-network relay UE is to relay the PDUs over the signalling radio bearer without modifications: (b) N2 connection between the 5G-AN and Access and Mobility Management Function (AMF) over N2; and (c) N3 connection between AMF and the Session Management Function (SMF) over N11. The role of the UE-to-network relay UE is to relay the PDUs from the signaling radio bearer without modifications.

FIG. 3 is a flow diagram illustrating a procedure for service continuity of layer 2 UE-to-network UE relay. The procedure is used for UE-to-network remote UE switching to direct path.

At step 1, the Uu measurement configuration and measurement report signalling procedures are performed to evaluate both relay link measurement and Uu link measurement. The measurement results from UE-to-network remote UE are reported when configured measurement reporting criteria are met. The sidelink relay measurement report includes at least UE-to-network relay UE's source L2 ID, serving cell ID (i.e., NCGI), and sidelink measurement quantity information. The sidelink measurement quantity can be SL-RSRP of the serving UE-to-network relay UE, and if SL-RSRP is not available, SD-RSRP is used.

At step 2, the gNB decides to switch the UE-to-network remote UE onto direct Uu path.

At step 3, the gNB sends RRCReconfiguration message to the UE-to-network remote UE. The UE-to-network remote UE stops user plane (UP) and control plane (CP) transmission 10 via UE-to-network relay UE after reception of RRCReconfiguration message from the gNB.

At step 4, the UE-to-network remote UE synchronizes with the gNB and performs random access.

At step 5, the UE (i.e., UE-to-network remote UE in previous steps) sends the RRCReconfigurationComplete to the gNB via direct path, using the configuration provided in the RRCReconfiguration message. From this step, the UE (i.e., UE-to-network remote UE in previous steps) uses the RRC connection via the direct path to the gNB.

At step 6, the gNB sends RRCReconfiguration message to the UE-to-network relay UE to reconfigure the connection between the UE-to-network relay UE and the gNB. The RRCReconfiguration message to the UE-to-network relay UE may be sent any time after step 3 based on gNB implementation (e.g., to release Uu and PC5 relay radio link control (RLC) channel configuration for relaying, and bearer mapping configuration between PC5 RLC and Uu RLC).

At step 7, either UE-to-network relay UE or UE-to-network remote UE may initiate the PC5 unicast link release (PC5-S). The timing to execute link release is up to UE implementation. The UE-to-network relay UE can execute PC5 connection reconfiguration to release PC5 relay RLC channel for relaying upon reception of RRC Reconfiguration by gNB in Step 6, or the UE (i.e., previous UE-to-network remote UE) may execute PC5 connection reconfiguration to release PC5 relay RLC channel for relaying upon reception of RRCReconfiguration by gNB in Step 3.

At step 8, the data path is switched from indirect path to direct path between the UE (i.e., previous UE-to-network remote UE) and the gNB. The downlink/uplink lossless delivery during the path switch is done according to PDCP data recovery procedure. Step 8 can be executed any time after step 4. Step 8 is independent of step 6 and step 7.

The gNB can select a UE-to-network relay UE in any RRC state i.e., RRC_IDLE, RRC_INACTIVE, or RRC_CONNECTED, as a target UE-to-network relay UE for direct to indirect path switch.

FIG. 4 is a flow diagram illustrating a procedure for service continuity of L2 UE-to-network remote UE. The procedure is used for the L2 UE-to-network remote UE switching to indirect path via a UE-to-network relay UE in RRC_CONNECTED.

At step 1, the UE-to-network remote UE reports one or multiple candidate UE-to-network relay UE(s) and Uu measurements, after it measures/discovers the candidate UE-to-network relay UE(s). The UE may filter the appropriate UE-to-network relay UE(s) according to relay selection criteria before reporting. The UE reports only the UE-to-network relay UE candidate(s) that fulfil the higher layer criteria. The reporting may include at least UE-to-network relay UE ID, UE-to-network relay UE's serving cell ID, and sidelink measurement quantity information. The sidelink measurement quantity can be SL-RSRP of the candidate UE-to-network Relay UE, and if SL-RSRP is not available, SD-RSRP is used.

At step 2, the gNB decides to switch the UE-to-network remote UE to a target UE-to-network relay UE. Then the gNB sends an RRCReconfiguration message to the target UE-to-network relay UE, which can include at least remote UE's local ID and L2 ID, Uu and PC5 relay RLC channel configuration for relaying, and bearer mapping configuration.

At step 3, the gNB sends the RRCReconfiguration message to the UE-to-network remote UE. The contents in the RRCReconfiguration message can include at least UE-to-network relay UE ID, PC5 relay RLC channel configuration for relay traffic and the associated end-to-end radio bearer(s). The UE-to-network remote UE stops UP and CP transmission over Uu after reception of RRCReconfiguration message from the gNB.

At step 4, the UE-to-network remote UE establishes PC5 connection with target UE-to-network relay UE.

At step 5, the UE-to-network remote UE completes the path switch procedure by sending the RRCReconfigurationComplete message to the gNB via the relay UE.

At step 6, the data path is switched from direct path to indirect path between the UE-to-network remote UE and the gNB.

If the selected UE-to-network relay UE for direct to indirect path switch is in RRC IDLE or RRC_INACTIVE, after receiving the path switch command, the UE-to-network remote UE establishes a PC5 link with the UE-to-network relay UE and sends the RRCReconfigurationComplete message via the UE-to-network relay UE, which triggers the UE-to-network relay UE to enter RRC_CONNECTED state. The procedure for UE-to-network remote UE switching to indirect path in FIG. 4 may also be applied when the selected UE-to-network relay UE for direct to indirect path switch is in RRC_IDLE or RRC_INACTIVE with the exception that step 4 is performed before step 2.

There currently exist certain challenges. For example, a relay UE that is in RRC_IDLE/RRC_INACTIVE may be chosen by the network to be a target relay UE for a remote UE during the path switch procedure. Regarding how the target relay UE understands that it needs to transition to RRC_CONNECTED (for the path switch procedure to be completed), the network does not necessarily page the target relay UE, but the target relay UE may understand that it needs to transition to RRC_CONNECTED when receiving a message from the remote UE for establishing the PC5 connection.

However, even if this solution works for the scenarios in which the remote UE and relay UE are under the coverage of the same gNB, when the target relay UE belongs to a different gNB with respect to the one of the remote UE, the path switch procedure cannot be completed. In particular, one problem with the current state of the art is that the source network node, when triggering the handover request over X2/Xn to the target network node, needs to mandatorily include the UE context information of the UE that needs to perform the handover. For sidelink relay, this means that the source node should transfer to the target node the relay UE ID and possible UE context, if any. For the remote UE there is no problem (because the remote UE is RRC CONNECTED during a path switch), but for the relay UE that is in RRC_IDLE/RRC_INACTIVE the UE context is not available at the source node (and thus cannot be forwarded to the target node). This is because no UE context is stored at the network for a UE in RRC_IDLE and only the UE AS inactive context (that is different from the UE context in RRC_CONNECTED) is stored at the network when a UE is in RRC_INACTIVE.

Given this situation, and according to section 8.2.1.4 in TS 38.423, the target network node will reject the handover when the target relay UE is in RRC_IDLE/RRC INACTIVE. The current specification (clause 8.2.1.4 of TS 38.423) indicates that if the supported algorithms for encryption defined in the UE Security Capabilities IE in the UE Context Information IE, plus the mandated support of the EEA0 and NEA0 algorithms in all UEs (TS 33.501), do not match any allowed algorithms defined in the configured list of allowed encryption algorithms in the NG-RAN node (TS 33.501), the NG-RAN node shall reject the procedure using the HANDOVER PREPARATION FAILURE message. If the supported algorithms for integrity defined in the UE Security Capabilities IE in the UE Context Information IE, plus the mandated support of the EIA0 and NIA0 algorithms in all UEs (TS 33.501), do not match any allowed algorithms defined in the configured list of allowed integrity protection algorithms in the NG-RAN node (TS 33.501), the NG-RAN node shall reject the procedure using the HANDOVER PREPARATION FAILURE message.

Further, the UE Context Information IE within the Handover Request message is marked as “reject” in the Assigned Criticality column (see section 9.1.1.1 of TS 38.423) and this means that if the IE cannot be comprehended by the target network node, this triggers handover failure. Also, the same UE Context Information IE is marked as “mandatory”, but because the source network node cannot fill it (because there is no UE context stored at the source node) then an abstract syntax error will be triggered at the target network node and the handover will fail.

The example of the UE Context Information IE is just one example, but other IEs present in the Handover Request message may have the same problem and thus may lead to a persistent handover (path switch) failure when selecting a target relay UE that is in RRC_IDLE/RRC_INACTIVE.

### SUMMARY

As described above, certain challenges currently exist with handover for sidelink relay user equipment. Certain aspects of the present disclosure and their embodiments may provide solutions to these or other challenges. For example, particular embodiments facilitate a target network node to not trigger a handover preparation failure message when receiving a handover request for path switch where the target relay user equipment (UE) is in RRC_IDLE or RRC INACTIVE.

In some embodiments, the source network node adds a flag over the inter-node radio resource control (RRC) message or X2/Xn message to indicate to the target network node that the target relay UE for the path switch to be executed is in RRC_IDLE or RRC_INACTIVE. In response to the flag, the target node does not treat the absence of a mandatory field(s) in the Handover Request message as a failure and thus will not trigger the Handover Preparation Failure message.

Some embodiments use a new set of X2/Xn messages for the path switch procedure for sidelink relay. This means that legacy messages like the Handover Request message, Handover Success message or Handover Preparation message are not used for the path switch procedure (i.e., the path switch procedure is treated separately from the handover procedure).

In some embodiments, when triggering the path switch procedure with a target relay UE that is in RRC_IDLE/RRC_INACTIVE, the source network node includes only information related to the remote UE that needs to switch its path to an indirect link (with the target relay UE that is in RRC_IDLE/RRC_INACTIVE). On the other side, when the remote UE sends the first message to establish a PC5 connection to the target relay UE, the target relay UE first performs the random access (and RRC setup or RRC resume procedure) towards the target network node, and then the target network node will configure the relay UE to accommodate the sidelink relay path with the remote UE.

According to some embodiments, a method is performed by a remote wireless device for performing a sidelink path switch. The method comprises receiving, from a source network node, a path switch command instructing the remote wireless device to switch to sidelink communication with a target relay wireless device. The target relay wireless device is in an idle or inactive state and the target relay wireless device is served by a target network node different from the source network node. The method further comprises establishing a sidelink connection to the target relay wireless device using information from the path switch command.

In particular embodiments, establishing the sidelink connection to the target relay wireless device comprises transmitting configuration information to the target relay wireless device based on information from the path switch command.

In particular embodiments, the configuration information comprises any one or more of: an indication the sidelink connection establishment is because of a path switch procedure: an identifier of the target network node; and an indication that the target relay wireless device should transition to a connected state.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method is performed by a source network node for performing a sidelink path switch. The method comprises determining to switch a remote wireless device to sidelink communication with a target relay wireless device. The target relay wireless device is in an idle or inactive state and the target relay wireless device is served by a target network node different from the source network node. The method further comprises transmitting an indication to the target network node of the path switch involving the target relay wireless device.

In particular embodiments, the indication to the target network node of the path switch involving the target relay wireless device comprises an indication in a handover command for the target relay wireless device. The indication in the handover command indicates to the target network node that one or more mandatory information elements are not included in the handover command. In some embodiments, the indication to the target network node of the path switch involving the target relay wireless device comprises a path switch command for the second relay wireless device. The path switch command indicates to the target network node that one or more mandatory information elements for a handover command are not included in the path switch command.

In particular embodiments, the indication of the path switch involving the target relay wireless device indicates one or more of: an indication of an ongoing path switch: an indication that a relay wireless device belongs to another network node as a target relay for a path switch: an indication that the target relay wireless device is in an idle or inactive state: an identifier of the target relay wireless device; and context information of the target relay wireless device.

According to some embodiments, a method is performed by a target network node for performing a sidelink path switch. The method comprises receiving an indication from a source network node of a path switch for a remote wireless device to sidelink communication with target relay wireless device. The target relay wireless device is in an idle or inactive state and the target relay wireless device is served by the target network node, which is different from the source network node. The method further comprises configuring the target relay wireless device to serve as a relay wireless device for the remote wireless device.

In particular embodiments, the indication from the source network node of the path switch comprises an indication in a handover command for the target relay wireless device. The indication in the handover command indicates to the target network node that one or more mandatory information elements are not included in the handover command. In some embodiments, the indication from the source network node of the path switch comprises a path switch command for the target relay wireless device. The path switch command indicates to the target network node that one or more mandatory information elements for a handover command are not included in the path switch command.

In particular embodiments, the indication of the path switch indicates one or more of: an indication of an ongoing path switch: an indication that a relay wireless device belongs to another network node as a target relay for a path switch: an indication that the second relay wireless device is in an idle or inactive state: an identifier of the target relay wireless device: and context information of the target relay wireless device.

According to some embodiments, a network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network nodes described above.

Certain embodiments may provide one or more of the following technical advantages. For example, particular embodiments facilitate a target network node to not trigger a handover preparation failure message when receiving a handover request with missing information for a path switch where the target relay UE is in RRC_IDLE or RRC_INACTIVE. This avoids persistent handover failure when a relay UE in RRC_IDLE/RRC_INACTIVE is selected as a target relay UE and also avoids long connectivity interruptions, increased signaling overhead, and power consumption (on both UE and network side).

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the protocol stack for user plane transport for a layer 2 user equipment (UE)-to-network relay UE;

FIG. 2 illustrates the protocol stack of the non-access stratum (NAS) connection for the remote UE to the NAS-MM and NAS-SM components:

FIG. 3 is a flow diagram illustrating a procedure for service continuity of layer 2 UE-to-network UE relay:

FIG. 4 is a flow diagram illustrating a procedure for service continuity of L2 UE-to-network remote UE:

FIG. 5 is a block diagram illustrating an example network configuration for a path switch to a UE belonging to a different gNB:

FIG. 6 is a flow diagram that illustrates the steps described in the third group of embodiments:

FIG. 7 is a block diagram illustrating an example wireless network;

FIG. 8 illustrates an example user equipment, according to certain embodiments:

FIG. 9 is flowchart illustrating an example method in a wireless device, according to certain embodiments:

FIG. 10A is a flowchart illustrating an example method in a source network node, according to certain embodiments:

FIG. 10B is a flowchart illustrating an example method in a target network node, according to certain embodiments:

FIG. 11 illustrates a schematic block diagram of a wireless device and network node in a wireless network, according to certain embodiments;

FIG. 12 illustrates an example virtualization environment, according to certain embodiments:

FIG. 13 illustrates an example telecommunication network connected via an intermediate network to a host computer, according to certain embodiments:

FIG. 14 illustrates an example host computer communicating via a base station with a user equipment over a partially wireless connection, according to certain embodiments: FIG. 15 is a flowchart illustrating a method implemented, according to certain embodiments:

FIG. 16 is a flowchart illustrating a method implemented in a communication system, according to certain embodiments:

FIG. 17 is a flowchart illustrating a method implemented in a communication system, according to certain embodiments; and

FIG. 18 is a flowchart illustrating a method implemented in a communication system, according to certain embodiments.

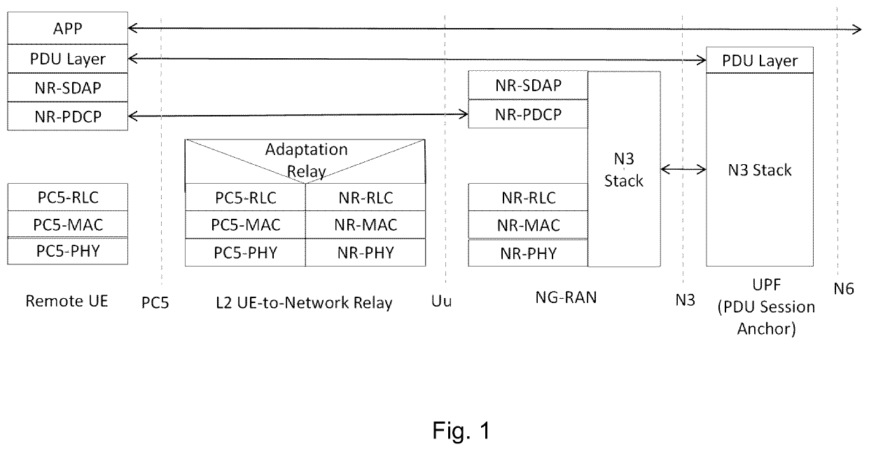

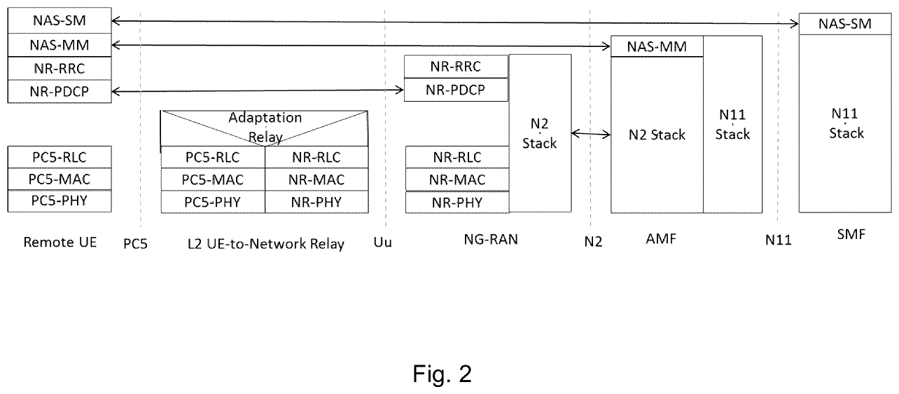

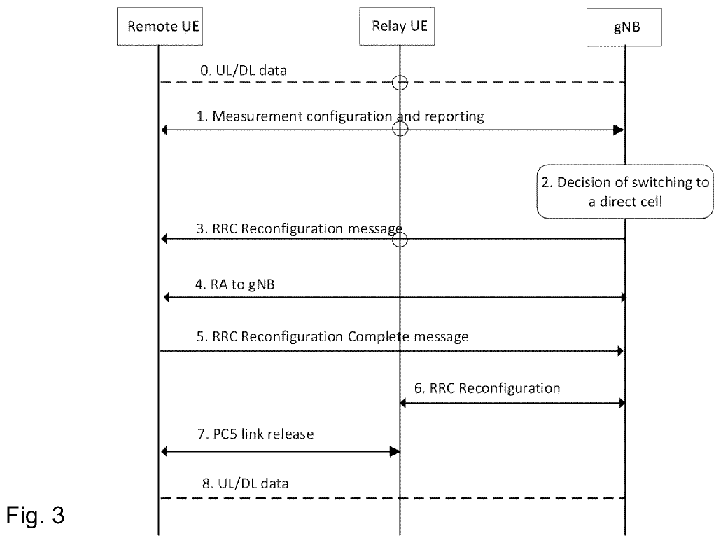

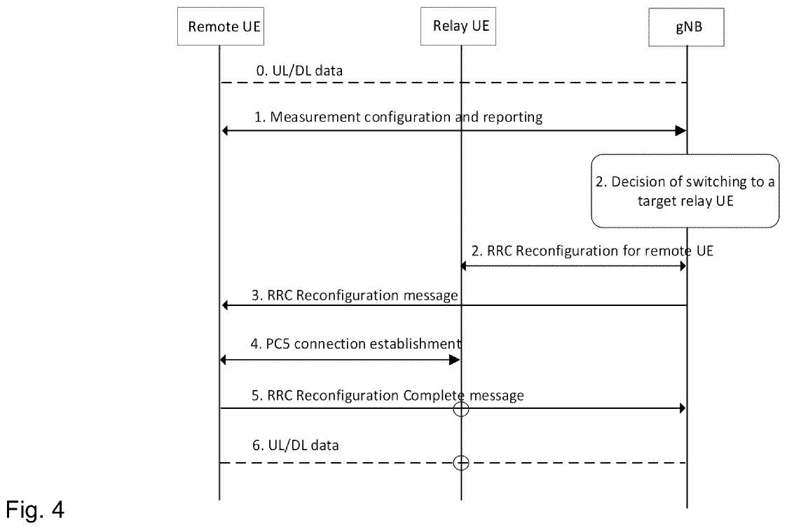

### DETAILED DESCRIPTION

As described above, certain challenges currently exist with handover for sidelink relay user equipment. Certain aspects of the present disclosure and their embodiments may provide solutions to these or other challenges. For example, particular embodiments facilitate a target network node to not trigger a handover preparation failure message when receiving a handover request for path switch where the target relay user equipment (UE) is in RRC_IDLE or RRC_INACTIVE.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Particular embodiments are described in the context of New Radio (NR), i.e., remote user equipment (UE) and relay UE are deployed in a same or different NR cell. The embodiments are also applicable to other relay scenarios including UE to network relay or UE to UE relay where the remote UE and the relay UE may be based on Long Term Evolution (LTE) sidelink or NR sidelink. The Uu connection between the relay UE and the base station may be LTE Uu or NR Uu.

The terms “direct connection” or “direct path” refer to a connection between a UE and a gNB, while the terms “indirect connection” or “indirect path” refer to a connection between a remote UE and gNB via a relay UE. In addition, the term “path switch” is used when the remote UE changes between a direct path (i.e., Uu connection) and an indirect path (i.e., relay connection via a sidelink (SL) relay UE). Other terms, such as “relay selection/reselection” are equally applicable without losing any meaning. Also, in particular embodiments the term “path switch” is used to describe a UE that is connected via direct path and needs to perform a path switch to an indirect path or a UE that is connected via an indirect path and needs to perform a path switch to an indirect path or direct path. On the contrary, the term “handover” is used to describe only the case when a UE is connected to a direct path towards a first network and is handed off to a new indirect path towards a second network.

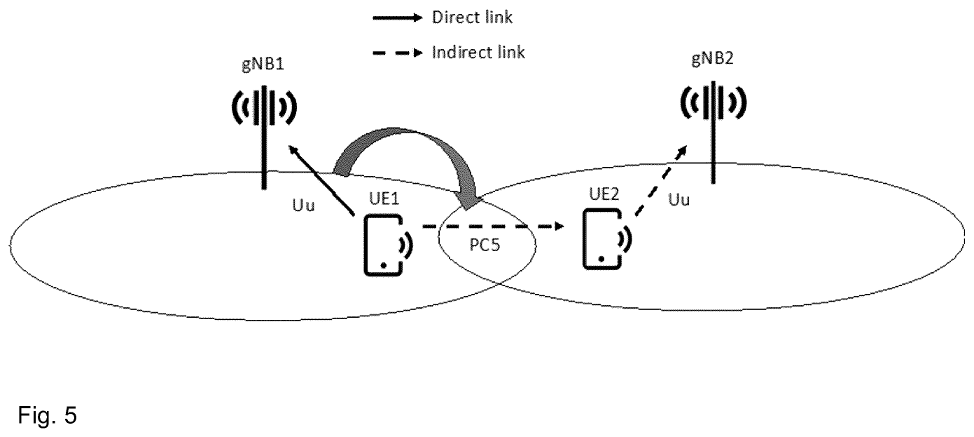

FIG. 5 is a block diagram illustrating an example network configuration for a path switch to a UE belonging to a different gNB. In the illustrated example, the remote UE sends a measurement report to the gNB with a list of candidate relay UEs for which their RRC status may be either RRC_CONNECTED, RRC_IDLE, or RRC_INACTIVE. Particular embodiments are directed to when a relay UE in RRC_IDLE or RRC_INACTIVE belonging to a different gNB is selected by the serving gNB of the remote UE as target relay UE for the path switch.

A first group of embodiments includes a flag in signaling between source network node (e.g., gNB1) and target network node (e.g., gNB2). In some embodiments, the source network node (e.g., gNB1), upon selecting a relay UE (e.g., UE2) in RRC_IDLE/RRC_INACTIVE belonging to another gNB (e.g., gNB2) as a target relay for the path switch of the remote UE (e.g., UE1), sends an indication to the target network node to indicate that there is a path switch ongoing and that a relay UE (e.g., UE2) in RRC_IDLE/RRC_INACTIVE has been selected as the target relay UE for the path switch.

In some embodiments, the indication may be a single bit indication where value “1” indicates that there is a path switch ongoing and that a relay UE (e.g., UE2) in RRC IDLE/RRC_INACTIVE has been selected as the target relay UE for the path switch and value “0” otherwise (also the meaning of value “1” and “0” can be inverted). In some embodiments, value “1” and “0” may be exchanged with value “true” or “false”, or value “present” and “absent” or any other value that may indicate that there is a path switch ongoing and that a relay UE (e.g., UE2) in RRC_IDLE/RRC_INACTIVE has been selected as the target relay UE for the path switch.

In some embodiments, the indication sent by the source network node to the target network node may be a structure comprising multiple information. In particular, the source network node may send within the indication at least one or more of the following information: (a) whether there is a path switch ongoing: (b) whether a relay UE (e.g., UE2) in RRC_IDLE/RRC_INACTIVE belonging to another gNB (e.g., gNB2) is a target relay for the path switch: (c) whether the relay UE selected as target relay UE is in RRC_IDLE or RRC_INACTIVE: (d) relay UE IDs (e.g., RNTI, TMSI): (e) relay UE sidelink IDs (e.g., L2 ID); and/or (f) latest UE context info of the relay UE (if the source network node has stored history of the UE context of the relay UE).

In some embodiments, upon receiving an indication from the source network node that a relay UE (e.g., UE2) in RRC_IDLE/RRC_INACTIVE has been selected as a target relay for the path switch of the remote UE (e.g., UE1), the target network node does not trigger a handover failure when some relay UE information are missing over the X2/Xn signaling exchange between the source network node and the target network node. In particular, missing information refers to any one or more of the following: (a) a field or information element (IE) that is declared as mandatory to be included/signaled and that is not included/signaled by the source node; and/or (b) a field or information element (IE) with an Assigned Criticality marked as “reject” and that is not included or signaled by the source node.

In some embodiments, the indication is sent by the source network node to the target network node via an existing or new inter-node RRC message. In some embodiments, the indication is sent by the source network node via new or existing X2/Xn signaling. For existing X2/Xn signaling, the indication may be included in the HANDOVER REQUEST message or EARLY STATUS TRANFER message.

Example implementation in TS 38.423:8.

### 2.1.2 Successful Operation

<legacy text omitted>

If the SL Relay Indicator IE is contained in the HANDOVER REQUEST message, the target NG-RAN node shall, if supported, consider that the handover is for Sidelink relay services.

### 9.1.1.1 Handover Request

This message is sent by the source NG-RAN node to the target NG-RAN node to request the preparation of resources for a handover.

Direction: source NG-RAN node→target NG-RAN node.

| | | | IE type and | | | Assigned |
|---|---|---|---|---|---|---|
| IE/Group Name | Presence | Range | reference | Semantics description | Criticality | Criticality |
| Message Type | M | | 9.2.3.1 | | YES | reject |
| Source NG- | M | | NG-RAN node | Allocated at the source NG- | YES | reject |
| RAN node UE | | | UE XnAP ID | RAN node | | |
| XnAP ID | | | 9.2.3.16 | | | |
| reference | | | | | | |
| Cause | M | | 9.2.3.2 | | YES | reject |
| Target Cell | M | | 9.2.3.25 | Includes either an E-UTRA | YES | reject |
| Global ID | | | | CGI or an NR CGI | | |
| GUAMI | M | | 9.2.3.24 | | YES | reject |
| UE Context | | 1 | | | YES | reject |
| Information | | | | | | |
| >NG-C UE | M | | AMF UE | Allocated at the AMF on the | — | |
| associated | | | NGAP ID | source NG-C connection. | | |
| Signalling | | | 9.2.3.26 | | | |
| reference | | | | | | |
| >Signalling | M | | CP Transport | This IE indicates the AMF's IP | — | |
| TNL | | | Layer | address of the SCTP | | |
| association | | | Information | association used at the source | | |
| address at | | | 9.2.3.31 | NG-C interface instance. | | |
| source NG-C | | | | Note: If no UE TNLA binding | | |
| side | | | | exists at the source NG-RAN | | |
| | | | | node, the source NG-RAN | | |
| | | | | node indicates the TNL | | |
| | | | | association address it would | | |
| | | | | have selected if it would have | | |
| | | | | had to create a UE TNLA | | |
| | | | | binding. | | |
| >UE Security | M | | 9.2.3.49 | | — | |
| Capabilities | | | | | | |
| >AS Security | M | | 9.2.3.50 | | — | |
| Information | | | | | | |
| >Index to | O | | 9.2.3.23 | | — | |
| RAT/Frequency | | | | | | |
| Selection | | | | | | |
| Priority | | | | | | |
| >UE | M | | 9.2.3.17 | | — | |
| Aggregate | | | | | | |
| Maximum Bit | | | | | | |
| Rate | | | | | | |
| >PDU | | 1 | 9.2.1.1 | Similar to NG-C signalling, | — | |
| Session | | | | containing UL tunnel | | |
| Resources To | | | | information per PDU Session | | |
| Be Setup List | | | | Resource; | | |
| | | | | and in addition, the source | | |
| | | | | side QoS flow ⇔ DRB | | |
| | | | | mapping | | |
| >RRC | M | | OCTET | Either includes the | — | |
| Context | | | STRING | HandoverPreparationinformation | | |
| | | | | message as defined in | | |
| | | | | subclause 10.2.2. of TS | | |
| | | | | 36.331, or the | | |
| | | | | HandoverPreparationInformation- | | |
| | | | | NB message as defined in | | |
| | | | | subclause 10.6.2 of TS | | |
| | | | | 36.331, if the target NG-RAN | | |
| | | | | node is an ng-eNB, | | |
| | | | | or the | | |
| | | | | HandoverPreparationInformation | | |
| | | | | message as defined in | | |
| | | | | subclause 11.2.2 of TS | | |
| | | | | 38.331, if the target NG-RAN | | |
| | | | | node is a gNB. | | |
| >Location | O | | 9.2.3.47 | Includes the necessary | — | |
| Reporting | | | | parameters for location | | |
| Information | | | | reporting. | | |
| >Mobility | O | | 9.2.3.53 | | — | |
| Restriction | | | | | | |
| List | | | | | | |
| >Management | O | | MDT PLMN | | YES | ignore |
| Based MDT | | | List | | | |
| PLMN List | | | 9.2.3.133 | | | |
| >5GC Mobility | O | | 9.2.3.100 | | YES | ignore |
| Restriction | | | | | | |
| List Container | | | | | | |
| >NR UE | O | | 9.2.3.107 | This IE applies only if the UE | YES | ignore |
| Sidelink | | | | is authorized for NR V2X | | |
| Aggregate | | | | services. | | |
| Maximum Bit | | | | | | |
| Rate | | | | | | |
| >LTE UE | O | | 9.2.3.108 | This IE applies only if the UE | YES | ignore |
| Sidelink | | | | is authorized for LTE V2X | | |
| Aggregate | | | | services. | | |
| Maximum Bit | | | | | | |
| Rate | | | | | | |
| >UE Radio | O | | 9.2.3.138 | | YES | reject |
| Capability ID | | | | | | |
| Trace | O | | 9.2.3.55 | | YES | ignore |
| Activation | | | | | | |
| Masked | O | | 9.2.3.32 | | YES | ignore |
| IMEISV | | | | | | |
| UE History | M | | 9.2.3.64 | | YES | ignore |
| Information | | | | | | |
| UE Context | O | | | | YES | ignore |
| Reference at | | | | | | |
| the S-NG-RAN | | | | | | |
| node | | | | | | |
| >Global NG- | M | | 9.2.2.3 | | — | |
| RAN Node ID | | | | | | |
| >S-NG-RAN | M | | NG-RAN node | | — | |
| node UE | | | UE XnAP ID | | | |
| XnAP ID | | | 9.2.3.16 | | | |
| Conditional | O | | | | YES | reject |
| Handover | | | | | | |
| Information | | | | | | |
| Request | | | | | | |
| >CHO Trigger | M | | ENUMERATED | | — | |
| | | | (CHO- | | | |
| | | | initiation, | | | |
| | | | CHO-replace, . . .) | | | |
| >Target NG- | C- | | NG-RAN node | Allocated at the target NG- | — | |
| RAN node UE | ifCHOmod | | UE XnAP ID | RAN node | | |
| XnAP ID | | | 9.2.3.16 | | | |
| >Estimated | O | | INTEGER | | — | |
| Arrival | | | (1 . . . 100) | | | |
| Probability | | | | | | |
| NR V2X | O | | 9.2.3.105 | | YES | ignore |
| Services | | | | | | |
| Authorized | | | | | | |
| LTE V2X | O | | 9.2.3.106 | | YES | ignore |
| Services | | | | | | |
| Authorized | | | | | | |
| PC5 QoS | O | | 9.2.3.109 | This IE applies only if the UE | YES | ignore |
| Parameters | | | | is authorized for NR V2X | | |
| | | | | services. | | |
| Mobility | O | | BIT STRING | Information related to the | YES | ignore |
| Information | | | (SIZE (32)) | handover; the source NG- | | |
| | | | | RAN node provides it in order | | |
| | | | | to enable later analysis of the | | |
| | | | | conditions that led to a wrong | | |
| | | | | HO. | | |
| UE History | O | | 9.2.3.110 | | YES | ignore |
| Information | | | | | | |
| from the UE | | | | | | |
| IAB Node | 0 | | ENUMERATE | | YES | reject |
| Indication | | | D (true, . . .) | | | |
| SL Relay | | | | | YES | ignore |
| Information | | | | | | |
| >Path Switch | O | | ENUMERATE | If included, the Source NG- | — | |
| Indicator | | | D (true, . . .) | RAN node UE XnAP ID | | |
| | | | | reference and the UE Context | | |
| | | | | Information shall be ignored. | | |
| >Relay UE ID | O | | TMSI or L2 ID | | — | |
| >Relay UE | | | UE Context | | — | |
| Context | | | Information | | | |

| | Explanation |
|---|---|
| Condition | |
| ifCHOmod | This IE shall be present if the CHO Trigger IE |
| | is present and set to “CHO-replace”. |
| Range bound | |
| maxnoofMDTPLMNs | PLMNs in the Management Based MDT PLMN list. Value is 16. |

In a second group of embodiments, new X2/Xn messages are used for the path switch procedure. In some embodiments, the X2/Xn signaling for the path switch procedure is separated from the X2/Xn signaling for the handover procedure. This means that the path switch and handover procedure use a different set of X2/Xn messages and procedures. Only information necessary for the path switch procedure is included in the new X2/Xn messages and the target network node acts accordingly with the information received (thus the problem linked to the legacy messages used for the handover case disappear). Further, the new set of X2/Xn messages for the path switch procedure may also include the indication described in the first group of embodiments.

### Example Implementation in TS 38.423:

NOTE: The following messages and text are completely new and not present in any legacy text.

### 9.1.1.1 Sidelink Relay Path Switch Request

This message is sent by the source NG-RAN node to the target NG-RAN node to request the path switch for Sidelink Relay services.

Direction: source NG-RAN node→target NG-RAN node.

| | | | IE type and | | | Assigned |
|---|---|---|---|---|---|---|
| IE/Group Name | Presence | Range | reference | Semantics description | Criticality | Criticality |
| Message Type | M | | 9.2.3.1 | | YES | reject |
| Source NG-RAN | O | | NG-RAN | Allocated at the source NG-RAN | YES | reject |
| node UE XnAP | | | node UE | node | | |
| ID reference | | | XnAP ID | | | |
| | | | 9.2.3.16 | | | |
| Cause | M | | 9.2.3.2 | | YES | reject |
| Target Cell | M | | 9.2.3.25 | Includes either an E-UTRA CGI | YES | reject |
| Global ID | | | | or an NR CGI | | |
| GUAMI | M | | 9.2.3.24 | | YES | reject |
| Remote UE | | 1 | | | YES | reject |
| Context | | | | | | |
| Information | | | | | | |
| >NG-C UE | M | | AMF UE | Allocated at the AMF on the | — | |
| associated | | | NGAP ID | source NG-C connection. | | |
| Signalling | | | 9.2.3.26 | | | |
| reference | | | | | | |
| >Signalling | M | | CP | This IE indicates the AMF's IP | — | |
| TNL | | | Transport | address of the SCTP | | |
| association | | | Layer | association used at the source | | |
| address at | | | Information | NG-C interface instance. | | |
| source NG-C | | | 9.2.3.31 | Note: If no UE TNLA binding | | |
| side | | | | exists at the source NG-RAN | | |
| | | | | node, the source NG-RAN node | | |
| | | | | indicates the TNL association | | |
| | | | | address it would have selected | | |
| | | | | if it would have had to create a | | |
| | | | | UE TNLA binding. | | |
| >UE Security | M | | 9.2.3.49 | | — | |
| Capabilities | | | | | | |
| >AS Security | M | | 9.2.3.50 | | — | |
| Information | | | | | | |
| >Index to | O | | 9.2.3.23 | | — | |
| RAT/Frequency | | | | | | |
| Selection | | | | | | |
| Priority | | | | | | |
| >UE | M | | 9.2.3.17 | | — | |
| Aggregate | | | | | | |
| Maximum Bit | | | | | | |
| Rate | | | | | | |
| >PDU Session | | 1 | 9.2.1.1 | Similar to NG-C signalling, | — | |
| Resources To | | | | containing UL tunnel information | | |
| Be Setup List | | | | per PDU Session Resource; | | |
| | | | | and in addition, the source side | | |
| | | | | QoS flow ⇔ DRB mapping | | |
| >RRC Context | M | | OCTET | Either includes the | | |
| | | | STRING | HandoverPreparationInformation | — | |
| | | | | message as defined in | | |
| | | | | subclause 10.2.2. of TS 36.331, | | |
| | | | | or the | | |
| | | | | HandoverPreparationInformation- | | |
| | | | | NB message as defined in | | |
| | | | | subclause 10.6.2 of TS 36.331, | | |
| | | | | if the target NG-RAN node is an | | |
| | | | | ng-eNB, | | |
| | | | | or the | | |
| | | | | HandoverPreparationInformation | | |
| | | | | message as defined in | | |
| | | | | subclause 11.2.2 of TS 38.331, | | |
| | | | | if the target NG-RAN node is a | | |
| | | | | gNB. | | |
| >Location | O | | 9.2.3.47 | Includes the necessary | — | |
| Reporting | | | | parameters for location | | |
| Information | | | | reporting. | | |
| >Mobility | O | | 9.2.3.53 | | — | |
| Restriction List | | | | | | |
| >5GC Mobility | O | | 9.2.3.100 | | YES | ignore |
| Restriction List | | | | | | |
| Container | | | | | | |
| >NR UE | O | | 9.2.3.107 | This IE applies only if the UE is | YES | ignore |
| Sidelink | | | | authorized for NR V2X services. | | |
| Aggregate | | | | | | |
| Maximum Bit | | | | | | |
| Rate | | | | | | |
| >UE Radio | O | | 9.2.3.138 | | YES | reject |
| Capability ID | | | | | | |
| Masked IMEISV | O | | 9.2.3.32 | | YES | ignore |
| UE History | M | | 9.2.3.64 | | YES | ignore |
| Information | | | | | | |
| UE Context | O | | | | YES | ignore |
| Reference at the | | | | | | |
| S-NG-RAN | | | | | | |
| node | | | | | | |
| >Global NG- | M | | 9.2.2.3 | | — | |
| RAN Node ID | | | | | | |
| >S-NG-RAN | M | | NG-RAN | | — | |
| node UE XnAP | | | node UE | | | |
| ID | | | XnAP ID | | | |
| | | | 9.2.3.16 | | | |
| NR V2X | O | | 9.2.3.105 | | YES | ignore |
| Services | | | | | | |
| Authorized | | | | | | |
| PC5 QoS | O | | 9.2.3.109 | This IE applies only if the UE is | YES | ignore |
| Parameters | | | | authorized for NR V2X services. | | |
| Mobility | O | | BIT | Information related to the | YES | ignore |
| Information | | | STRING | handover; the source NG-RAN | | |
| | | | (SIZE | node provides it in order to | | |
| | | | (32)) | enable later analysis of the | | |
| | | | | conditions that led to a wrong | | |
| | | | | HO. | | |
| SL Relay | | | | | YES | ignore |
| Information | | | | | | |
| >Relay UE ID | O | | TMSI or | | — | |
| | | | L2 ID | | | |
| >Relay UE | O | | UE Context | | — | |
| Context | | | Information | | | |

### 9.1.1.2 Sidelink Relay Path Switch Request Acknowledge

This message is sent by the target NG-RAN node to inform the source NG-RAN node about the prepared resources at the target for Sidelink Relay services.

Direction: target NG-RAN node→source NG-RAN node.

reference

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.3.1 | | YES | reject |
| Source NG-RAN node | O | NG-RAN | Allocated at the | YES | ignore |
| UE XnAP ID | | node UE | source NG-RAN | | |
| | | XnAP ID | node | | |
| | | 9.2.3.16 | | | |
| Target NG-RAN node | O | NG-RAN | Allocated at the | YES | ignore |
| UE XnAP ID | | node UE | target NG-RAN | | |
| | | XnAP ID | node | | |
| | | 9.2.3.16 | | | |
| PDU Session | M | 9.2.1.2 | | YES | ignore |
| Resources Admitted List | | | | | |
| PDU Session | O | 9.2.1.3 | | YES | ignore |
| Resources Not Admitted | | | | | |
| List | | | | | |
| Target NG-RAN node | M | OCTET | Either includes the | YES | ignore |
| To Source NG-RAN | | STRING | HandoverCommand | | |
| node Transparent | | | message as | | |
| Container | | | defined in | | |
| | | | subclause 10.2.2 of | | |
| | | | TS 36.331, if the | | |
| | | | target NG-RAN | | |
| | | | node is an ng-eNB, | | |
| | | | or the | | |
| | | | HandoverCommand | | |
| | | | message as | | |
| | | | defined in | | |
| | | | subclause 11.2.2 of | | |
| | | | TS 38.331, if the | | |
| | | | target NG-RAN | | |
| | | | node is a gNB. | | |
| Criticality Diagnostics | O | 9.2.3.3 | | YES | ignore |

In a third group of embodiments, a target relay UE in RRC_IDLE/RRC_INACTIVE first accesses the target network node. In some embodiments, the source network node (e.g., gNB1), upon selecting a relay UE (e.g., UE2) in RRC_IDLE/RRC_INACTIVE belonging to another gNB (e.g., gNB2) as a target relay for the path switch of the remote UE (e.g., UE1), only triggers the path switch procedure for the remote UE. In this case, in some embodiments the source network node may (or may not) include an indication that a path switch is ongoing and that a relay UE that is in RRC_IDLE/RRC_INACTIVE has been chosen as target relay UE for the path switch.

In some embodiments, upon receiving an indication from the source network node that a relay UE (e.g., UE2) in RRC_IDLE/RRC_INACTIVE has been selected as a target relay for the path switch of the remote UE (e.g., UE1), the target network node sends to the source network node the handover success message by including a configuration (basically the path switch command) that needs to be used by the remote UE. This configuration (or path switch command) to be used by the remote UE also includes an identifier of the target relay UE. The relay UE identifier may be a Uu identifier (such as RNTI, TMSI) or a sidelink identifier (e.g., the L2 ID). In addition, the configuration (or path switch command) may include a configuration for use by the target relay UE and that configuration is forwarded by the remote UE to the target relay UE over PC5.

In some embodiments, when receiving the path switch command (generated by the target network node) from the source network node, the remote UE triggers the sidelink connection establishment procedure to the target relay UE. When triggering the sidelink connection establishment to the target relay UE, the remote UE may include additional information to help the relay UE perform a particular action. The additional information that the remote UE may send to the target relay UE include any one or more of the following: (a) whether the sidelink connection establishment is because of a path switch procedure: (b) the cell ID to which the remote UE wants to connect (i.e., the target network node ID or another network node ID, for a multipath scenario): (c) the cell ID to which the relay UE should connect (i.e., the target node ID): (d) a configuration (generated by the target network node and received by the source network node) that the relay UE should use; and/or (e) an indication for the target relay UE that it needs to transition to RRC_CONNECTED.

In some embodiments, upon receiving a sidelink connection establishment message from a remote UE, a relay UE that is in RRC_IDLE/RRC_INACTIVE triggers the related RRC procedure to transition to RRC_CONNECTED towards the gNB with which the relay UE is currently camped. The RRC procedure may be the random access procedure and also the RRC setup or RRC resume procedure (depending on the RRC state of the relay UE at the time in which it needs to transit to RRC_CONNECTED). When performing the related RRC procedure to transit to RRC_CONNECTED, the target relay UE may use the legacy RRC messages as they are or may also include additional information within these RRC messages to indicate to the target network node that the transition to RRC_CONNECTED is because of a path switch procedure ongoing. The additional information that the target relay UE may send to the target node may include any one or more of the following: (a) an indication that the transition to RRC_CONNECTED is because of a path switch: (b) the remote UE Uu IDs (e.g., RNTI, TMSI): (c) the remote UE sidelink IDs (e.g., L2 ID); and/or (d) the ID of the source network node.

In some embodiments, if the target relay UE does not want to operate as a relay UE, when receiving the sidelink connection establishment message from the remote UE, the target relay UE may ignore the message or, alternatively, may send a message back to the remote UE with a reject indication or the message may be identified as a rejection (e.g., according to the name of the message).

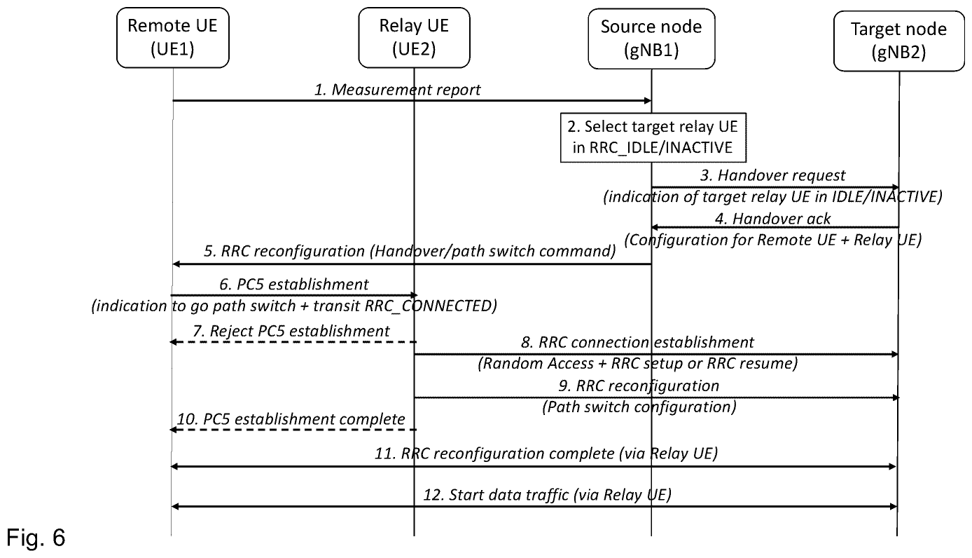

FIG. 6 is a flow diagram that illustrates the steps described in the third group of embodiments. In the illustrated example, at step 1 the remote UE (UE1) sends one or more measurement reports to the source network node (gNB1). The source network node, at step 2, selects a target relay UE based on the measurement reports received at step 1. The target relay UE is in an IDLE/INACTIVE state and is served by a different gNB, such as the target network node (gNB2). At step 3, the source network node send a handover request to the target network node. The handover request may include information about the target relay UE (UE2).

At step 4, the target network node sends a handover acknowledgment to the source network node. The handover acknowledgment may include configuration information for the remote UE and/or the target relay UE.

At step 5, the source network node sends an RRC reconfiguration message to the remote UE. The RRC reconfiguration may include a handover/path switch command.

At step 6, the remote UE initiates establishment of a PC5 connection with the target relay UE. The initiation may include an indication of the path switch and an indication to transition to RRC_CONNECTED. If the target relay UE does not want to become a relay UE, the target relay UE may reject the PC5 establishment at step 7. Otherwise, at step 8 the target relay UE sends an RRC connection establishment request to the target network node. The RRC connection establishment request may include a random access and RRC setup or a RRC resume. At step 9, the target relay UE sends a RRC reconfiguration to the target network node. The RRC reconfiguration may include a path switch configuration. At step 10, the target relay UE may signal PC5 establishment complete to the remote UE.

At step 11, the RRC reconfiguration is completed between the target network node and remote UE via signaling through the target relay UE. At step 12, the target network node exchanges data traffic with the remote UE via the target relay UE.

In some embodiments, the gNB determines which of the solutions and methods described the previous embodiments that the UE should use and communicates the determination to the UE via dedicated RRC signaling or via system information. In some embodiments, which option(s) the UE should use is decided by TX/RX UE or is pre-configured (hard-coded in a specification).

In some embodiments, for the above embodiments, the signaling alternatives described include at least one of the following. Signaling between gNBs may include: X2/Xn signaling: F1 signaling; and/or inter-node RRC messages. Signaling between UE and the gNB may include: RRC signaling; MAC CE; L1 signaling on channels such as PRACH, PUCCH, PDCCH; and/or control PDU of a protocol layer such as SDAP, PDCP, RLC or an adaptation layer which responsible for the duplication function. Signaling between UEs may include: RRC signaling (e.g., PC5-RRC): PC5-S signaling; discovery signaling; MAC CE: L1 signaling on channels such as PSSCH, PSCCH, or PSFCH; and/or control PDU of a protocol layer such as SDAP, PDCP, RLC or an adaptation layer responsible for the duplication function.

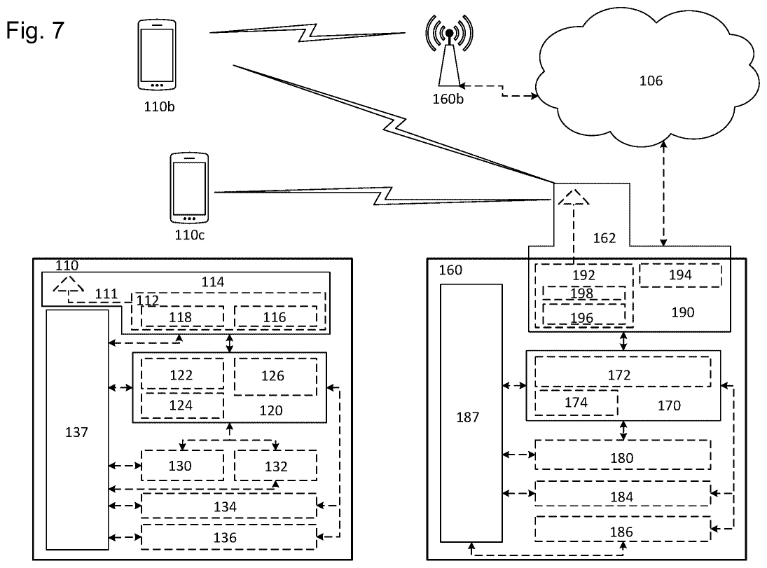

FIG. 7 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), New Radio (NR), and/or other suitable 2G, 3G, 4G, or 5G standards: wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 7, network node 160 includes processing circuitry 170, device readable medium 180, interface 190, auxiliary equipment 184, power source 186, power circuitry 187, and antenna 162. Although network node 160 illustrated in the example wireless network of FIG. 7 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB, gNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 7 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112: rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen: if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source: in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 7. For simplicity, the wireless network of FIG. 7 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

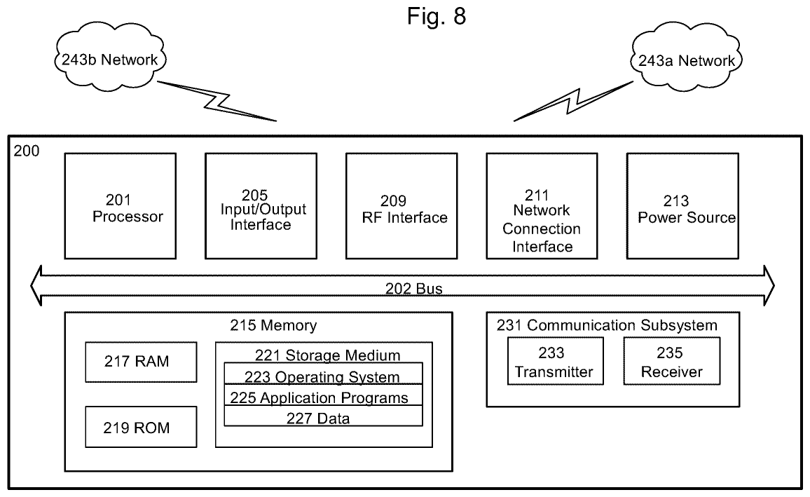

FIG. 8 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3rd Generation Partnership Project (3GPP), including a NB-IoT UE, a machine type communication (MTC) UE, and/or an enhanced MTC (eMTC) UE. UE 200, as illustrated in FIG. 8, is one example of a WD configured for communication in accordance with one or more communication standards promulgated by the 3rd Generation Partnership Project (3GPP), such as 3GPP's GSM, UMTS, LTE, and/or NR standards. As mentioned previously, the term WD and UE may be used interchangeable. Accordingly, although FIG. 8 is a UE, the components discussed herein are equally applicable to a WD, and vice-versa.

In FIG. 8, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.): programmable logic together with appropriate firmware: one or more stored program, general-purpose processors, such as a microprocessor or Digital Signal Processor (DSP), together with appropriate software: or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 8, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

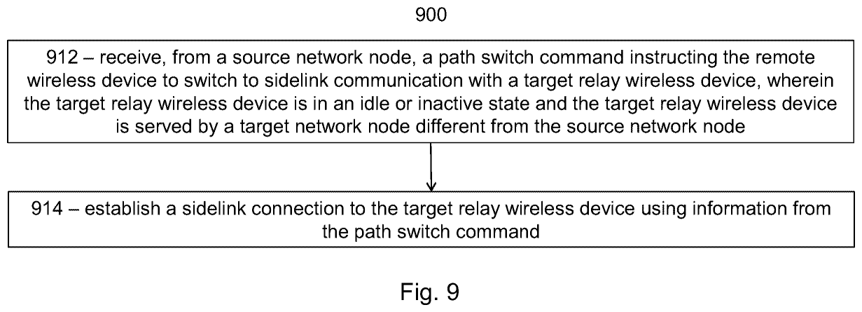

FIG. 9 is a flowchart illustrating an example method in a wireless device, according to certain embodiments. In particular embodiments, one or more steps of FIG. 9 may be performed by wireless device 110 described with respect to FIG. 7. The wireless device comprises a remote wireless device operable to perform a sidelink path switch.

The method begins at step 912, where the remote wireless device (e.g., wireless device 110) receives, from a source network node (e.g., network node 160), a path switch command instructing the remote wireless device to switch to sidelink communication with a target relay wireless device. The target relay wireless device is in an idle or inactive state and the target relay wireless device is served by a target network node different from the source network node.

At step 914, the remote wireless device establishes a sidelink connection to the target relay wireless device using information from the path switch command. In particular embodiments, establishing the sidelink connection to the target relay wireless device comprises transmitting configuration information to the target relay wireless device based on information from the path switch command. The configuration information may comprise any one or more of: an indication the sidelink connection establishment is because of a path switch procedure: an identifier of the target network node; and an indication that the target relay wireless device should transition to a connected state.

Modifications, additions, or omissions may be made to method 900 of FIG. 9. Additionally, one or more steps in the method of FIG. 9 may be performed in parallel or in any suitable order.

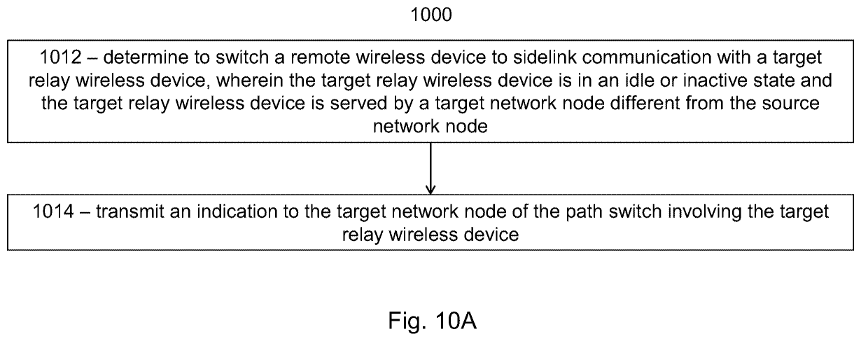

FIG. 10A is a flowchart illustrating an example method in a source network node, according to certain embodiments. In particular embodiments, one or more steps of FIG. 10A may be performed by network node 160 described with respect to FIG. 7. The source network node is operable to perform a sidelink path switch.

The method begins at step 1012, where the source network node (e.g., network node 160) determines to switch a remote wireless device to sidelink communication with a target relay wireless device. The target relay wireless device is in an idle or inactive state and the target relay wireless device is served by a target network node different from the source network node.

At step 1014, the source network node transmits an indication to the target network node of the path switch involving the target relay wireless device. In particular embodiments, the indication to the target network node of the path switch involving the target relay wireless device comprises an indication in a handover command for the target relay wireless device. The indication in the handover command indicates to the target network node that one or more mandatory information elements are not included in the handover command. In some embodiments, the indication to the target network node of the path switch involving the target relay wireless device comprises a path switch command for the second relay wireless device. The path switch command indicates to the target network node that one or more mandatory information elements for a handover command are not included in the path switch command.

In particular embodiments, the indication of the path switch involving the target relay wireless device indicates one or more of: an indication of an ongoing path switch: an indication that a relay wireless device belongs to another network node as a target relay for a path switch: an indication that the target relay wireless device is in an idle or inactive state: an identifier of the target relay wireless device; and context information of the target relay wireless device.

Modifications, additions, or omissions may be made to method 1000 of FIG. 10A. Additionally, one or more steps in the method of FIG. 10A may be performed in parallel or in any suitable order.

FIG. 10B is a flowchart illustrating an example method in a target network node, according to certain embodiments. In particular embodiments, one or more steps of FIG. 10B may be performed by network node 160 described with respect to FIG. 7. The target network node is operable to perform a sidelink path switch.

The method begins at step 1052, where the target network node (e.g., network node 160) receives an indication from a source network node of a path switch for a remote wireless device to sidelink communication with target relay wireless device. The target relay wireless device is in an idle or inactive state and the target relay wireless device is served by the target network node, which is different from the source network node.

In particular embodiments, the indication from the source network node of the path switch comprises an indication in a handover command for the target relay wireless device. The indication in the handover command indicates to the target network node that one or more mandatory information elements are not included in the handover command. In some embodiments, the indication from the source network node of the path switch comprises a path switch command for the target relay wireless device. The path switch command indicates to the target network node that one or more mandatory information elements for a handover command are not included in the path switch command.

In particular embodiments, the indication of the path switch indicates one or more of: an indication of an ongoing path switch; an indication that a relay wireless device belongs to another network node as a target relay for a path switch: an indication that the second relay wireless device is in an idle or inactive state: an identifier of the target relay wireless device; and context information of the target relay wireless device.

At step 1054, the target network node configures the target relay wireless device to serve as a relay wireless device for the remote wireless device.

Modifications, additions, or omissions may be made to method 1050 of FIG. 10B. Additionally, one or more steps in the method of FIG. 10B may be performed in parallel or in any suitable order.

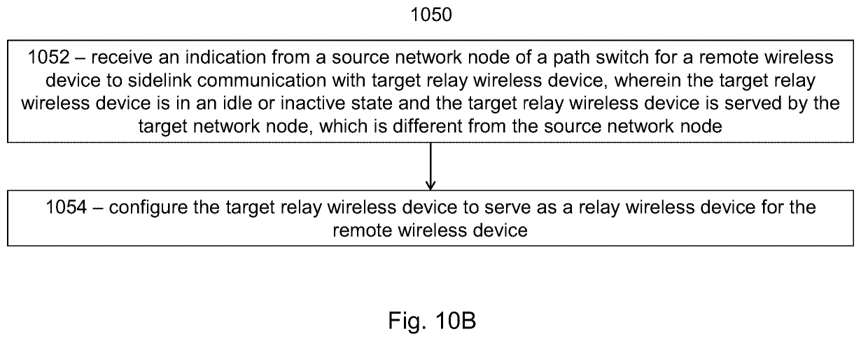

FIG. 11 illustrates a schematic block diagram of two apparatuses in a wireless network (for example, the wireless network illustrated in FIG. 7). The apparatuses include a wireless device and a network node (e.g., wireless device 110 and network node 160 illustrated in FIG. 7). Apparatuses 1600 and 1700 are operable to carry out the example methods described with reference to FIGS. 9 and 10A/10B, respectively, and possibly any other processes or methods disclosed herein. It is also to be understood that the methods of FIGS. 9 and 10A/10B are not necessarily carried out solely by apparatus 1600 and/or apparatus 1700. At least some operations of the method can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, determining module 1604, transmitting module 1606, and any other suitable units of apparatus 1600 to perform corresponding functions according one or more embodiments of the present disclosure. Similarly, the processing circuitry described above may be used to cause receiving module 1702, determining module 1704, transmitting module 1706, and any other suitable units of apparatus 1700 to perform corresponding functions according one or more embodiments of the present disclosure.

As illustrated in FIG. 11, apparatus 1600 includes receiving module 1602 configured to receive a path switch command, according to any of the embodiments and examples described herein. Apparatus 1600 also includes determining module 1604 configured to determine to perform a path switch, according to any of the embodiments and examples described herein. Transmitting module 1606 is configured to establish a sidelink connection, according to any of the embodiments and examples described herein.

As illustrated in FIG. 11, apparatus 1700 includes receiving module 1702 configured to receive a path switch indication according to any of the embodiments and examples described herein. Determining module 1704 is configured to determine to switch a remote wireless device to sidelink communication with a target relay wireless device, according to any of the embodiments and examples described herein. Transmitting module 1706 is configured to transmit an indication to a target network node of a path switch, according to any of the embodiments and examples described herein.

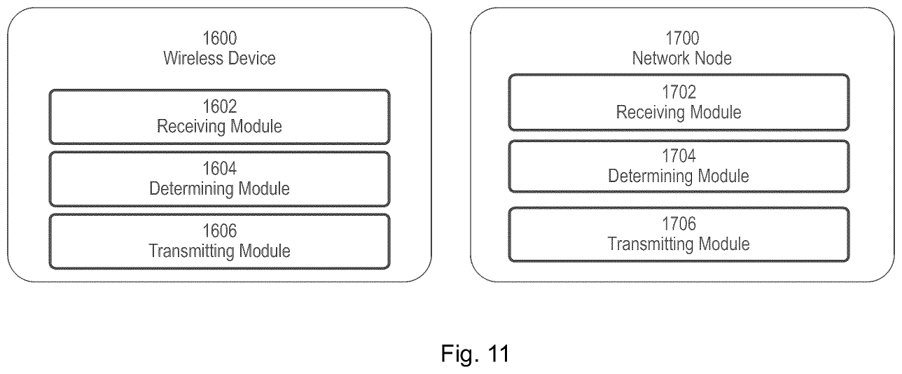

FIG. 12 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 12, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

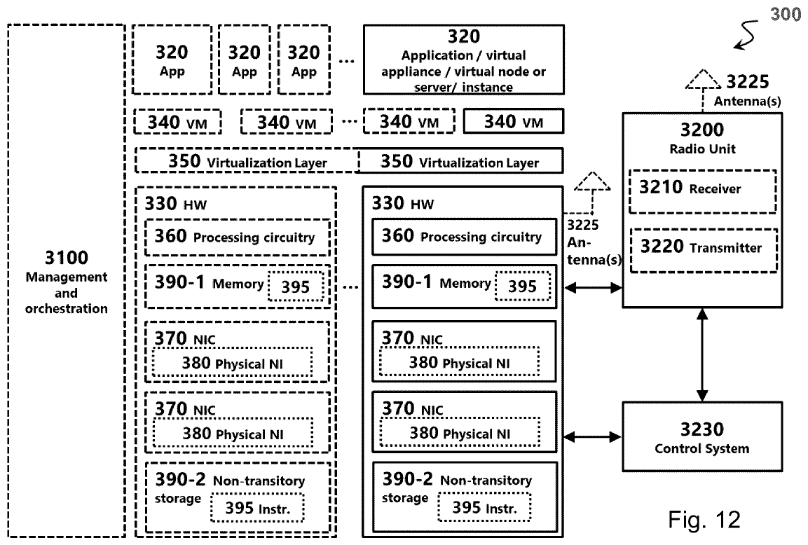

Still in the context of NFV, Virtual Network Function (VNF) is responsible for handling specific network functions that run in one or more virtual machines 340 on top of hardware networking infrastructure 330 and corresponds to application 320 in FIG. 13.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

With reference to FIG. 13, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network: intermediate network 420, if any, may be a backbone network or the Internet: in particular, intermediate network 420 may comprise two or more sub-networks (not shown).

The communication system of FIG. 13 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

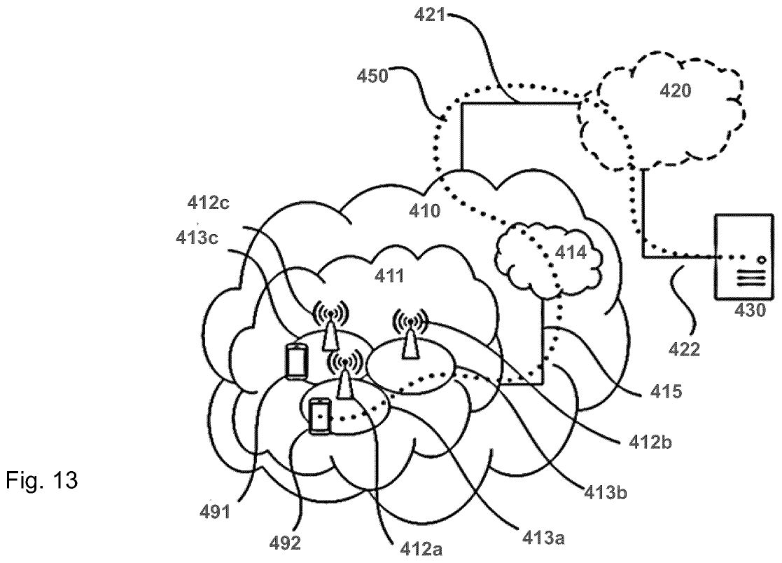

FIG. 14 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 14. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 14) served by base station 520. Communication interface 526 may be configured to facilitate connection 560 to host computer 510. Connection 560 may be direct, or it may pass through a core network (not shown in FIG. 14) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 14 may be similar or identical to host computer 430, one of base stations 412a, 412b, 412c and one of UEs 491, 492 of FIG. 13, respectively. This is to say, the inner workings of these entities may be as shown in FIG. 14 and independently, the surrounding network topology may be that of FIG. 13.

In FIG. 14, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, and thereby provide benefits such as reduced user waiting time, better responsiveness and extended battery life.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes: the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.: the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

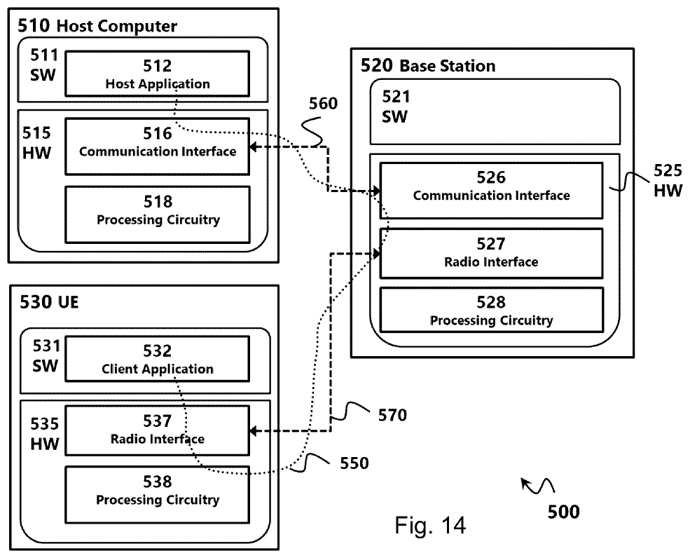

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

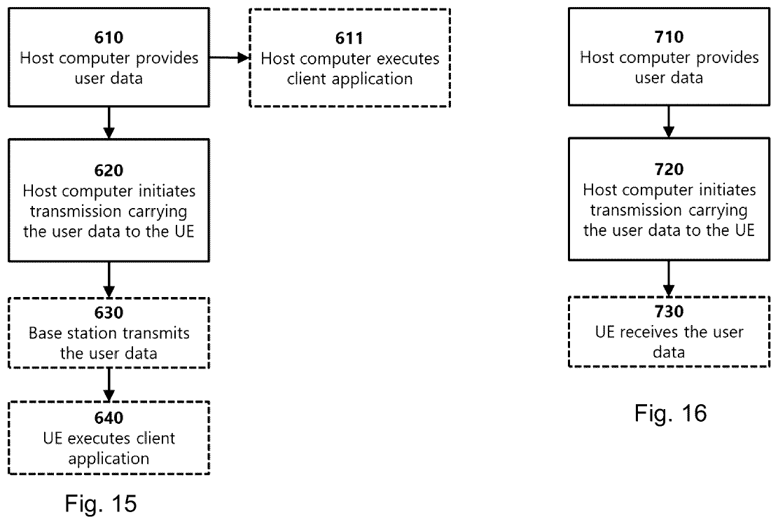

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

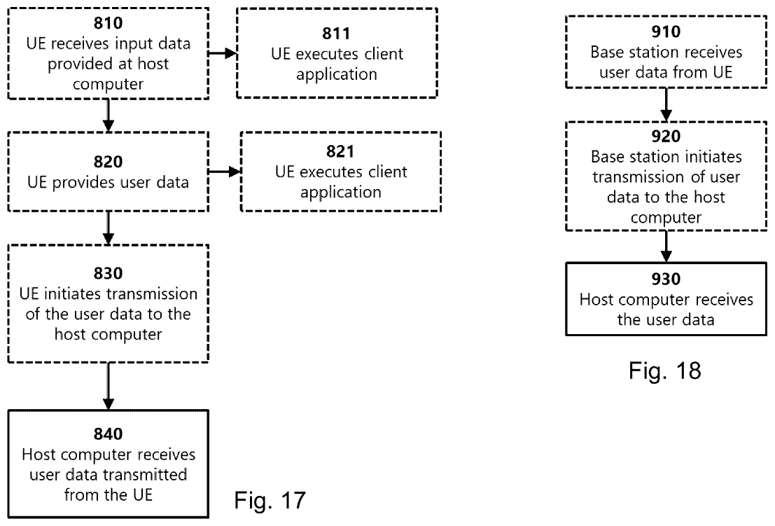

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment.” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a source network node for performing a sidelink path switch, the method comprising:
determining to switch a remote wireless device to sidelink communication with a target relay wireless device, wherein the target relay wireless device is in an idle or inactive state and the target relay wireless device is served by a target network node different from the source network node; and
transmitting an indication to the target network node of the path switch involving the target relay wireless device.

2. The method of claim 1, wherein the indication to the target network node of the path switch involving the target relay wireless device comprises an indication in a handover command for the target relay wireless device, and wherein the indication in the handover command indicates to the target network node that one or more mandatory information elements are not included in the handover command.

3. The method of claim 1, wherein the indication to the target network node of the path switch involving the target relay wireless device comprises a path switch command for the second relay wireless device, and wherein the path switch command indicates to the target network node that one or more mandatory information elements for a handover command are not included in the path switch command.

4. The method of claim 1, wherein the indication of the path switch involving the target relay wireless device indicates one or more of:
an indication of an ongoing path switch;
an indication that a relay wireless device belongs to another network node as a target relay for a path switch:
an indication that the target relay wireless device is in an idle or inactive state:
an identifier of the target relay wireless device; and
context information of the target relay wireless device.

5. A source network node operable to perform a sidelink path switch, the network node comprising processing circuitry operable to:
determine to switch a remote wireless device to sidelink communication with a target relay wireless device, wherein the target relay wireless device is in an idle or inactive state and the target relay wireless device is served by a target network node different from the source network node; and
transmit an indication to the target network node of the path switch involving the target relay wireless device.

6. The source network node of claim 5, wherein the indication to the target network node of the path switch involving the target relay wireless device comprises an indication in a handover command for the target relay wireless device, and wherein the indication in the handover command indicates to the target network node that one or more mandatory information elements are not included in the handover command.

7. The source network node of claim 5, wherein the indication to the target network node of the path switch involving the target relay wireless device comprises a path switch command for the second relay wireless device, and wherein the path switch command indicates to the target network node that one or more mandatory information elements for a handover command are not included in the path switch command.

8. The source network node of claim 5, wherein the indication of the path switch involving the target relay wireless device indicates one or more of:
an indication of an ongoing path switch;
an indication that a relay wireless device belongs to another network node as a target relay for a path switch;
an indication that the target relay wireless device is in an idle or inactive state:
an identifier of the target relay wireless device; and
context information of the target relay wireless device.

9. A method performed by a target network node for performing a sidelink path switch, the method comprising:
receiving an indication from a source network node of a path switch for a remote wireless device to sidelink communication with target relay wireless device, wherein the target relay wireless device is in an idle or inactive state and the target relay wireless device is served by the target network node, which is different from the source network node; and
configuring the target relay wireless device to serve as a relay wireless device for the remote wireless device.

10. The method of claim 9, wherein the indication from the source network node of the path switch comprises an indication in a handover command for the target relay wireless device, and wherein the indication in the handover command indicates to the target network node that one or more mandatory information elements are not included in the handover command.

11. The method of claim 9, wherein the indication from the source network node of the path switch comprises a path switch command for the target relay wireless device, and wherein the path switch command indicates to the target network node that one or more mandatory information elements for a handover command are not included in the path switch command.

12. The method of claim 9, wherein
the indication of the path switch indicates one or more of:
an indication of an ongoing path switch:
an indication that a relay wireless device belongs to another network node as a target relay for a path switch;
an indication that the second relay wireless device is in an idle or inactive state:
an identifier of the target relay wireless device; and
context information of the target relay wireless device.

13. A target network node operable to perform a sidelink path switch, the network node comprising processing circuitry operable to:
receive an indication from a source network node of a path switch for a remote wireless device to sidelink communication with a target relay wireless device, wherein the target relay wireless device is in an idle or inactive state and the target relay wireless device is served by the target network node, which is different from the source network node; and
configure the target relay wireless device to serve as a relay wireless device for the remote wireless device.

14. The target network node of claim 13, wherein the indication from the source network node of the path switch comprises an indication in a handover command for the target relay wireless device, and wherein the indication in the handover command indicates to the target network node that one or more mandatory information elements are not included in the handover command.

15. The target network node of claim 13, wherein the indication from the source network node of the path switch comprises a path switch command for the target relay wireless device, and wherein the path switch command indicates to the target network node that one or more mandatory information elements for a handover command are not included in the path switch command.

16. The target network node of claim 13, wherein the indication of the path switch indicates one or more of:
an indication of an ongoing path switch:
an indication that a relay wireless device belongs to another network node as a target relay for a path switch;
an indication that the second relay wireless device is in an idle or inactive state;
an identifier of the target relay wireless device; and
context information of the target relay wireless device.

17.-19. (canceled)

20. A remote wireless device is operable to perform a sidelink path switch, the wireless device comprising processing circuitry operable to:
receive, from a source network node, a path switch command instructing the remote wireless device to switch to sidelink communication with a target relay wireless device, wherein the target relay wireless device is in an idle or inactive state and the target relay wireless device is served by a target network node different from the source network node; and
establishing a sidelink connection to the target relay wireless device using information from the path switch command.

21. The remote wireless device of claim 17, wherein the processing circuitry is operable to establish the sidelink connection to the target relay wireless device by transmitting configuration information to the target relay wireless device based on information from the path switch command.

22. The remote wireless device of claim 21, wherein the configuration information comprises any one or more of:
an indication the sidelink connection establishment is because of a path switch procedure;
an identifier of the target network node; and
an indication that the target relay wireless device should transition to a connected state.
